(19) United States
(12) Patent Application Publication
(10) Pub. No.: US 2026/0123805 A1
(43) Pub. Date: May 7, 2026

(54) ELECTRONIC DEVICE

(71) Applicant: SAMSUNG ELECTRONICS CO., LTD., Suwon-si (KR)

(72) Inventors: Jisu KIM, Suwon-si (KR); Hunsung Kim, Suwon-si (KR); Yousub Lee, Suwon-si (KR); Daesu Choi, Suwon-si (KR); Daegun Hong, Suwon-si (KR)

(73) Assignee: SAMSUNG ELECTRONICS CO., LTD., Suwon-si (KR)

(21) Appl. No.: 19/371,480

(22) Filed: Oct. 28, 2025

Related U.S. Application Data
(63) Continuation of application No. PCT/KR2025/015217, filed on Sep. 26, 2025.

(30) Foreign Application Priority Data
Nov. 1, 2024 (KR) 10-2024-0153814

(51) Int. Cl. A47L 9/28; G03B 29/00

(52) U.S. Cl. CPC A47L 9/2836; A47L 9/2805; A47L 2201/04; G03B 29/00

(57) ABSTRACT

An electronic device includes: a housing; a wheel on a lower portion of the housing; a sensor configured to detect an object; a supporter on which the sensor is provided, the supporter including a guide hole and being configured to be movable in a vertical direction with the sensor; a shaft configured to be insertable into the guide hole of the supporter and configured to guide movement of the supporter; and a power transmission assembly on a lateral side of the supporter and configured to transmit power to the supporter, where the guide hole includes a laterally elongated shape and is configured to prevent interference between the supporter and the shaft.

### CROSS-REFERENCE TO RELATED APPLICATION(S)

This application is a continuation of International Application No. PCT/KR2025/015217, filed on Sep. 26, 2025, in the Korean Intellectual Property Receiving Office, which is based on and claims priority to Korean Patent Application No. 10-2024-0153814, filed on Nov. 1, 2024, in the Korean Intellectual Property Office, the disclosures of which are incorporated by reference herein in their entireties.

### BACKGROUND

### 1. Field

The disclosure relates to an electronic device.

### 2. Description of Related Art

An electronic device may include a main body and a traveling device such as wheels provided to move the main body. Through the above configuration, the electronic device may be easily movable within a space.

The electronic device may include a sensor for detecting obstacles. The electronic device may use information detected by the sensor to avoid obstacles or map movable areas.

Some examples of the electronic device having the above configuration may include a projector that is movably provided to project images to arbitrary areas, and a robot cleaner that is movably provided to perform a cleaning function at arbitrary positions.

### SUMMARY

Provided is an electronic device with a compact structure.

Further, provided is an electronic device with an extended lifespan.

Further, provided is an electronic device with improved aesthetics.

Additional aspects will be set forth in part in the description which follows and, in part, will be apparent from the description, or may be learned by practice of the presented embodiments.

According to an aspect of the disclosure, an electronic device may include: a housing; a wheel on a lower portion of the housing; a sensor configured to detect an object; a supporter on which the sensor is provided, the supporter including a guide hole and being configured to be movable in a vertical direction with the sensor; a shaft configured to be insertable into the guide hole of the supporter and configured to guide movement of the supporter; and a power transmission assembly on a lateral side of the supporter and configured to transmit power to the supporter, where the guide hole includes a laterally elongated shape and is configured to prevent interference between the supporter and the shaft.

The sensor may be configured to be switchable between a first position in which the sensor protrudes from an upper portion of the housing and a second position in which the sensor is accommodated inside the housing, based on a movement of the supporter along the vertical direction.

The supporter may further include a second guide hole spaced apart from the guide hole and including a circular shape, where the electronic device further includes a second shaft spaced apart from the shaft and configured to be insertable into the second guide hole.

The electronic device may further include a motor configured to generate the power, where the power transmission assembly includes: a first gear on the supporter and extending along the vertical direction; and a second gear coupled to a rotation shaft of the motor and configured to engage with the first gear.

The electronic device may further include: a motor configured to generate the power; and a motor cover surrounding the motor and configured to dampen vibration generated by the motor.

The electronic device may further include a motor configured to generate the power, where the guide hole has a first length extending in a direction of a rotation shaft of the motor and a second length extending in a direction intersecting the direction of the rotation shaft of the motor, and where the second length is greater than the first length.

The electronic device may further include: a motor configured to generate the power; a base on which the supporter is supportable; and a bracket configured to fix the motor to the base.

The bracket may include an upper surface portion, and a lower surface portion spaced apart from the upper surface portion in the vertical direction, where the electronic device further includes: a second sensor on the supporter and configured to contact the upper surface portion of the bracket when the sensor is at the first position; and a third sensor on the supporter and configured to contact the lower surface portion of the bracket when the sensor is at the second position.

The electronic device may further include a controller configured to stop an operation of the motor based on the second sensor contacting the upper surface portion of the bracket or the third sensor contacting the lower surface portion of the bracket.

The electronic device may further include a stopper configured to contact the supporter when the sensor is at the first position.

The stopper may be coupled to the shaft and provided above the guide hole.

The electronic device may further include a base on which the supporter is provided, where the shaft is configured to be press-fitted into the base.

The electronic device may further include a sensor cover on an upper portion of the sensor and forming at least part of an external portion of the housing when the sensor is at the second position.

The sensor may include a supporter mount configured to be mountable on the supporter, where the supporter includes a bottom portion on which the sensor is provided, a sidewall portion extending upward from the bottom portion, and a fixing hook formed on the sidewall portion and configured to fix the supporter mount.

The supporter mount may include a mounting hole, where the supporter further includes a mounting protrusion on the bottom portion and configured to be insertable into the mounting hole.

The electronic device may further include: a motor configured to generate the power, and a controller configured to operate the motor to position the sensor at the first position when the electronic device is in a traveling state, and to position the sensor at the second position when the electronic device is not in the traveling state.

According to an aspect of the disclosure, an electronic device may include: a housing; a traveling device on the housing; a sensor configured to detect an object; a supporter on which the sensor is provided, the supporter including a guide hole and being configured to be movable in a vertical direction with the sensor; a shaft configured to be insertable into the guide hole of the supporter and configured to guide movement of the supporter; and a motor mechanically coupled to the supporter and configured to generate power to move the supporter, where the guide hole includes a laterally elongated shape and is configured to prevent interference between the supporter and the shaft.

The sensor may be configured to be switchable between a first position in which the sensor protrudes from an upper portion of the housing and a second position in which the sensor is accommodated inside the housing, based on a movement of the supporter along the vertical direction.

The supporter may further include a second guide hole spaced apart from the guide hole and including a circular shape, where the electronic device further includes a second shaft spaced apart from the shaft and configured to be insertable into the second guide hole.

The guide hole may have a first length extending in a direction of a rotation shaft of the motor and a second length extending in a direction intersecting the direction of the rotation shaft of the motor, where the second length is greater than the first length.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 shows an electronic device in a traveling state according to an embodiment of the disclosure;

FIG. 2 shows an electronic device in a non-traveling state according to an embodiment of the disclosure;

FIG. 3 shows the interior of an electronic device according to an embodiment of the disclosure;

FIG. 4 shows an exploded view of a lifting assembly according to an embodiment of the disclosure;

FIG. 5 shows a first state of a lifting assembly according to an embodiment of the disclosure;

FIG. 6 is a cross-sectional view taken along line A-A′ of FIG. 5 according to an embodiment of the disclosure;

FIG. 7 is a cross-sectional view taken along line B-B′ of FIG. 5 according to an embodiment of the disclosure;

FIG. 8 shows a second state of a lifting assembly according to an embodiment of the disclosure;

FIG. 9 is a cross-sectional view taken along line C-C′ of FIG. 8 according to an embodiment of the disclosure;

FIG. 10 is a cross-sectional view taken along line D-D′ of FIG. 8 according to an embodiment of the disclosure;

FIG. 11 is a control block diagram of an electronic device according to an embodiment of the disclosure;

FIG. 12 shows a portion of a lifting assembly according to an embodiment of the disclosure;

FIG. 13 is a front view of the lifting assembly shown in FIG. 12 according to an embodiment of the disclosure;

FIG. 14 is a cross-sectional view taken along line E-E′ shown in FIG. 12 according to an embodiment of the disclosure;

FIG. 15 is an enlarged view of portion F shown in FIG. 14 according to an embodiment of the disclosure;

FIG. 16 is an enlarged view of portion G shown in FIG. 14 according to an embodiment of the disclosure;

FIG. 17 shows a motor and a motor cover according to an embodiment of the disclosure;

FIG. 18 shows an exploded view of the motor and the motor cover shown in FIG. 17 according to an embodiment of the disclosure;

FIG. 19 shows an electronic device in a traveling state according to an embodiment of the disclosure;

FIG. 20 shows an electronic device in a non-traveling state according to an embodiment of the disclosure; and

FIG. 21 shows an electronic device when viewed from below according to an embodiment of the disclosure.

### DETAILED DESCRIPTION

Various embodiments of the disclosure and terminology used herein are not intended to limit the technical features of the disclosure to the specific embodiments, but rather should be understood to cover all modifications, equivalents, and alternatives falling within the concept and scope of the disclosure.

In the description of the drawings, like numbers refer to like elements throughout the description of the drawings.

The singular forms preceded by “a,” “an,” and “the” corresponding to an item include the plural forms as well unless the context clearly indicates otherwise. In the disclosure, a phrase such as “A or B,” “at least one of A and B,” “at least one of A or B,” “A, B or C,” “at least one of A, B and C,” and “at least one of A, B, or C” includes any one of the items listed together in the corresponding phrase of the phrases, or any possible combination thereof.

The term “and/or” includes combinations of one or all of a plurality of associated listed items.

The terms as used throughout the specification, such as “˜ part”, “˜ module”, “˜ member”, “˜ block”, etc., may be implemented in software and/or hardware, and a plurality of “˜ parts”, “˜ modules”, “˜ members”, or “˜ blocks” may be implemented in a single element, or a single “˜ part”, “˜ module”, “˜ member”, or “˜ block” may include a plurality of elements.

As used herein, such terms as “1st” and “2nd,” or “first” and “second” is used to simply distinguish a corresponding component from another, and does not limit the components in other aspect (for example, importance or order).

When one (e.g., a first) element is referred to as being “coupled” or “connected” to another (e.g., a second) element with or without the term “functionally” or “communicatively,” it means that the one element is connected to the other element directly, wirelessly, or via a third element.

It will be understood that when the terms “includes,” “comprises,” “including,” “comprising,” “has”, “having”, and the like, when used in this specification, specify the presence of stated features, figures, steps, operations, components, members, or combinations thereof, but do not preclude the presence or addition of one or more other features, figures, steps, operations, components, members, or combinations thereof.

It will be understood that when a certain component is referred to as being “connected to”, “coupled to”, “supported by” or “in contact with” another component, it may be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a component is referred to as being “on” another component, it may be directly on the other component or intervening components may also be present.

The terms “front,” “rear,” “left,” “right,” “upper,” and “lower,” as used in the following description, are defined based on the drawings, and do not limit the shapes or positions of the respective components. For example, “front” and “rear” may be defined with reference to the X-axis shown in the drawings; “left” and “right” may be defined with reference to the Y-axis; and “upper” and “lower” may be defined with reference to the Z-axis.

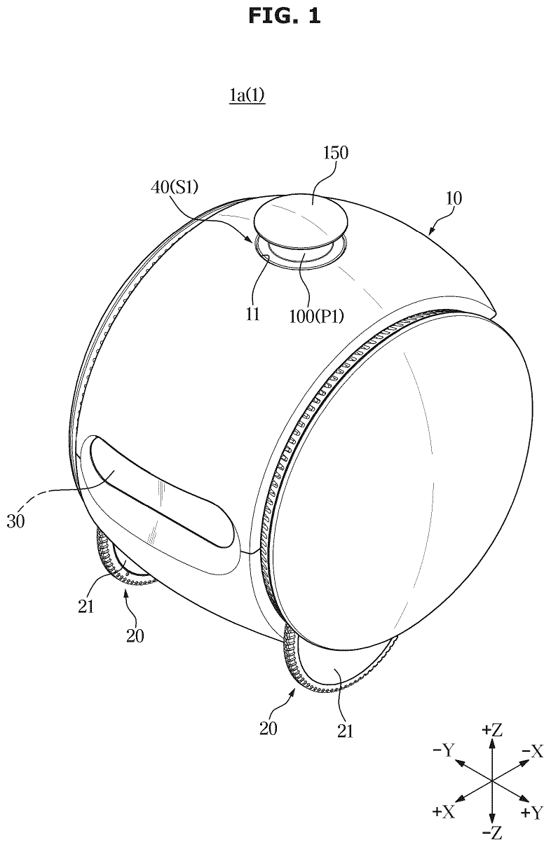

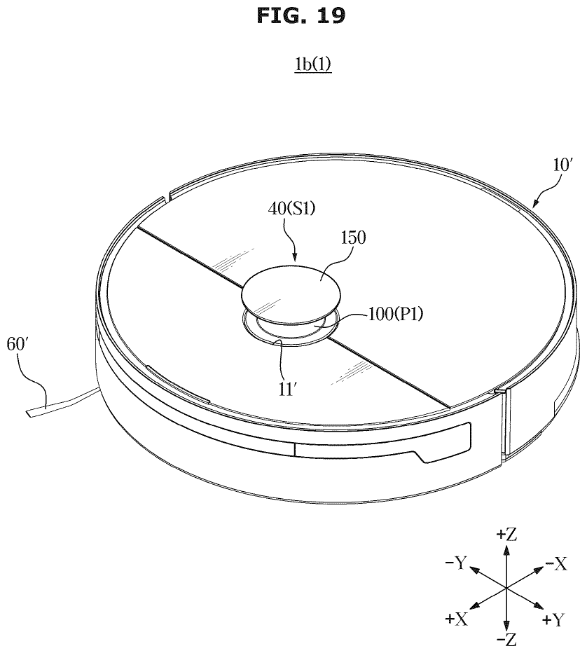

An electronic device 1 according to various embodiments of the disclosure may perform specific tasks while in the traveling state. For example, the electronic device 1 may include a projector 1a, (see FIGS. 1 to 3) movably provided to project images to arbitrary areas, or a robot cleaner 1b, (see FIGS. 19 to 21) movably provided to perform cleaning functions in arbitrary areas. However, the disclosure is not limited to these examples, and the disclosure may be applied to all devices capable of autonomous driving in addition to the above-described examples. The electronic device 1 may be referred to as an autonomous driving robot 1.

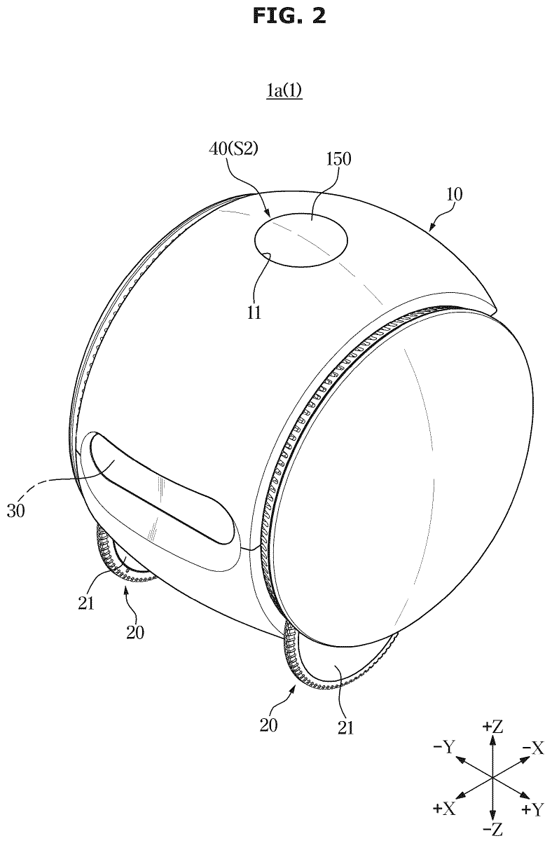

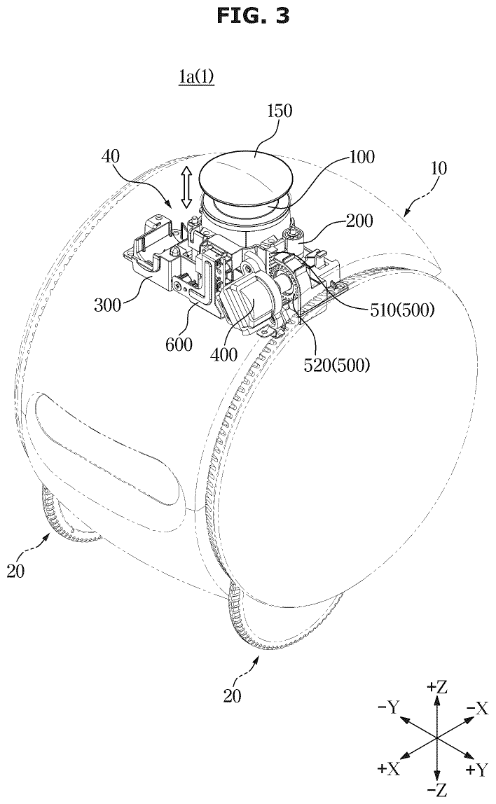

FIG. 1 shows an electronic device in a traveling state according to an embodiment of the disclosure. FIG. 2 shows an electronic device in a non-traveling state according to an embodiment of the disclosure. FIG. 3 shows the interior of an electronic device according to an embodiment of the disclosure.

Referring to FIGS. 1 to 3, a projector 1a will be described as an example of the electronic device 1.

The projector 1a may project images to arbitrary areas. For example, the projector 1a may project images onto a screen, a wall, a floor, a ceilings, furniture, or the like.

The projector 1a may include a housing 10. The housing 10 may form the overall appearance of the projector 1a. The housing 10 may be provided to accommodate various components of the projector 1a. For example, the housing 10 may be provided to accommodate a light source, an optical member for guiding light emitted from the light source toward a projection lens 30, and an image processing device (e.g., including an LCD panel, a DMD chips, and/or a LCOS panel). For example, the housing 10 may be provided to accommodate at least a portion of a lifting assembly 40 to be described below (see FIG. 3). The housing 10 may be referred to as a main body 10, a case 10, and the like.

The projector 1a may include a projection lens 30. The projection lens 30 may be provided to project an image generated by the projector 1a onto an arbitrary area. The projection lens 30 may adjust focus such that images appear clear. The projection lens 30 may adjust the image size according to the projection distance.

The projector 1a may include a traveling device 20. The traveling device 20 may be detachably mounted on a lower portion of the housing 10. The traveling device 20 may include at least one wheel 21 mounted on the lower portion of the housing 10 and provided to move the housing 10. As an example, the traveling device 20 may include a pair of wheels 21. The traveling device 20 may include a wheel driver for driving the wheels 21.

The projector 1a may include a lifting assembly 40. At least a portion of the lifting assembly 40 may be disposed inside the projector (1a, see FIG. 3). The lifting assembly 40 may include a sensor 100 for detecting an obstacle and components for moving the sensor 100 up and down. The lifting assembly 40 may also be referred to as a sensor assembly 40, or may be referred to as a pop-up assembly 40.

The lifting assembly 40 may be provided in a first state (S1, see FIG. 1) or a second state (S2, see FIG. 2). The lifting assembly 40 may be switchable between the first state S1 and the second state S2.

When an operation of the sensor 100 is needed (e.g., when the projector 1a is in a traveling state), the lifting assembly 40 may be provided in the first state S1. While the lifting assembly 40 is in the first state S1, the sensor 100 may be at a first position P1 in which the sensor 100 protrudes from the housing 10. As an example, the sensor 100 may protrude from the upper portion of the housing 10 through an opening 11 of the housing 10. While the projector 1a is in a traveling state, the sensor 100 may be exposed outside the housing 10 to detect objects located around the projector 1a.

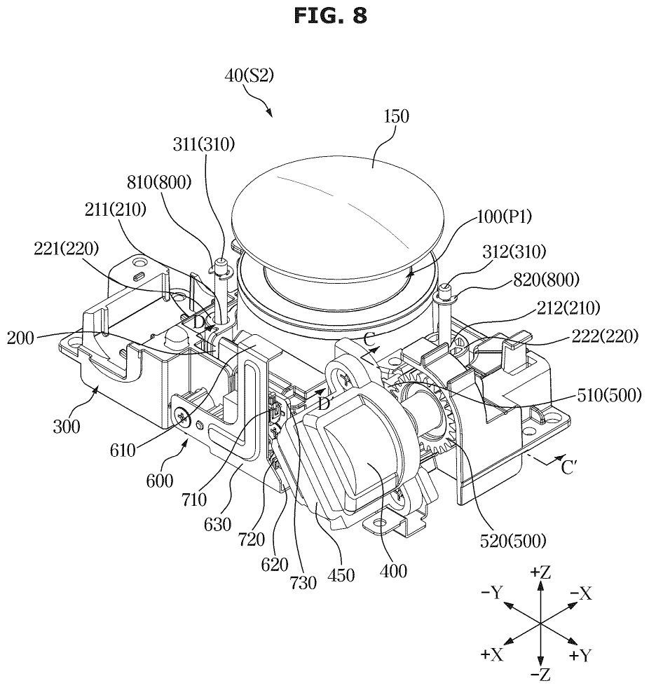

When an operation of the sensor 100 is not needed (e.g., when the projector 1a is not in a traveling state), the lifting assembly 40 may be provided in the second state S2. While the lifting assembly 40 is in the second state S2, the sensor 100 may be at a second position P2 in which the sensor 100 is accommodated inside the housing 10 (see FIG. 8). While the lifting assembly 40 is in the second state S2, the sensor 100 may be retracted into the housing 10. While the projector 1a is not in the traveling state, the sensor 100 may not be exposed outside the housing 10. While the projector 1a is not in the traveling state, the sensor 100 may be hidden inside the housing 10.

The lifting assembly 40 may include a sensor cover 150 provided to cover the upper portion of the sensor 100. When the sensor 100 is at the second position P2 (i.e., when the projector 1a is not in the traveling state), the sensor cover 150 may be provided to form a part of the external appearance of the projector 1a (see FIG. 2). The sensor cover 150 may be connected to the housing 10 without a step within a defined error range. The upper surface of the sensor cover 150 may be provided to smoothly continue with the outer surface of the housing 10. The sensor cover 150 and the housing 10 may form a substantially seamless external appearance. The sensor cover 150 may have a size corresponding to the opening 11 of the housing 10.

In summary, depending on whether the projector 1a is in a traveling state, the lifting assembly 40 may be provided in the first state (S1, see FIG. 1) or the second state (S2, see FIG. 2). The projector 1a may be in the traveling state when the projector 1a is in a mode configured to travel by using the sensor 100, regardless of whether or not the projector 1a is actually moving. Similarly, the projector 1a may not be in the traveling state when the projector 1a is not in the mode configured to travel, or when the projector 1a is in a mode configured to travel that does not use the sensor 100. Thus, the user may easily recognize whether the projector 1a is in a traveling state. In addition, the aesthetics of the projector 1a may be improved.

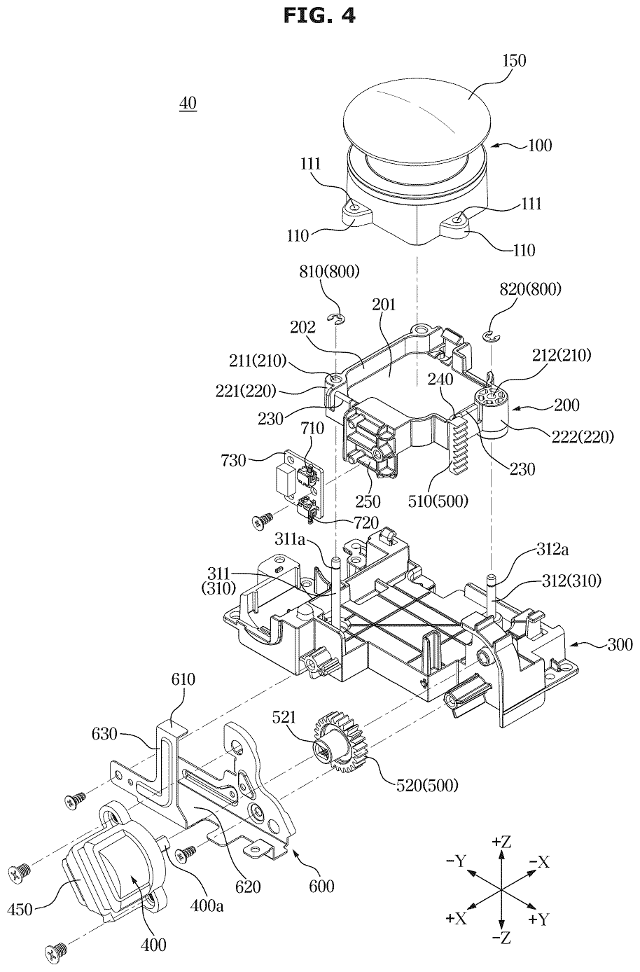

FIG. 4 shows an exploded view of a lifting assembly according to an embodiment of the disclosure.

The lifting assembly 40 may include a sensor 100. The sensor 100 may be provided to detect obstacles (external objects) (e.g., objects, people, pets, and the like). The sensor 100 may be provided to detect obstacles located on a traveling path of the projector 1a or around the projector 1a. The sensor 100 may be provided to detect the position of obstacles, the distance to obstacles, and the like. The sensor 100 may be referred to as an obstacle detection sensor 100.

For example, the sensor 100 may include a Light Detection and Ranging (LiDAR) sensor. The sensor 100 may emit light (pulse laser) to the outside and receive light reflected from an external object in a defined direction. The sensor 100 may be rotatable approximately 360-degree in a clockwise or counterclockwise direction. The sensor 100 may emit light in approximately 360 degrees and receive reflected light, and thus the sensor 100 may detect external objects in all directions. However, the disclosure is not limited to the above example, and the sensor 100 may include various sensors capable of detecting obstacles.

The sensor 100 may include a supporter mounting portion 110. The supporter mounting portion 110 may also be referred to as a supporter mount 110. The supporter mounting portion 110 may be provided to be mountable on a supporter 200 to be described below. As an example, the supporter mounting portion 110 may include a mounting hole 111, and a mounting protrusion 240 of the supporter 200 may be inserted into the mounting hole 111. Thus, the sensor 100 may be stably supported by the supporter 200.

The lifting assembly 40 may include a sensor cover 150. The sensor cover 150 may be provided to cover the upper portion of the sensor 100. The sensor cover 150 may be detachably coupled to the upper portion of the sensor 100 or may be formed integrally with the sensor 100.

The lifting assembly 40 may include a supporter 200. The supporter 200 may be provided to support the sensor 100. The sensor 100 may be seated on the supporter 200. The supporter 200 may also be referred to as a support frame 200, support assembly 200, support frame assembly 200, or the like.

The supporter 200 may be configured to be movable in the vertical direction. The supporter 200 is movable in the vertical direction (Z direction) together with the sensor 100. As the supporter 200 moves in the vertical direction, the sensor 100 supported by the supporter 200 may also move in the vertical direction. The supporter 200 may be provided to move the sensor 100 up and down.

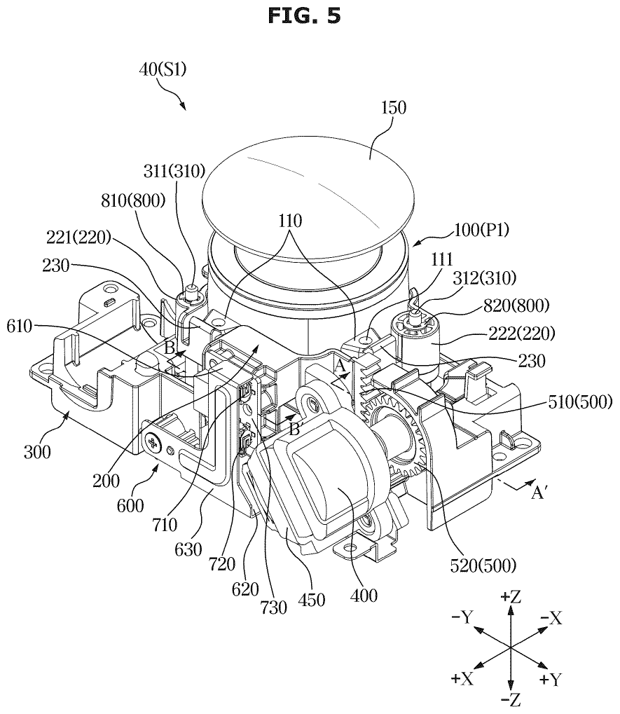

As the supporter 200 moves along the vertical direction, the lifting assembly 40 is switchable between the first state (S1, see FIG. 1) and the second state (S2, see FIG. 2). As the supporter 200 moves along the vertical direction, the sensor 100 may be switchable between a first position (P1, see FIG. 5) at which the sensor 100 protrudes from the upper portion of the housing 100 and a second position P2, see FIG. 8) at which the sensor 100 is accommodated inside the housing 100. The sensor 100 may be movable between the first position (P1, see FIG. 5) and the second position P2, see FIG. 8). The sensor 100 may be configured to move in the vertical direction between the first position (P1, see FIG. 5) and the second position P2, see FIG. 8). The sensor 100 may move downward from the first position P1 to reach the second position P2. The sensor 100 may move upward from the second position P2 to reach the first position P1.

For example, the supporter 200 may include a bottom portion 201 on which the sensor 100 is seated, and a sidewall portion 202 extending upward from the bottom portion 201. The supporter 200 may form a space for accommodating at least a portion of the sensor 100. The space may be formed by the bottom portion 201 and the sidewall portion 202.

The supporter 200 may include a guide hole 210. The guide hole 210 may be configured such that a shaft 310 to be described below may be inserted into the guide hole 210. With the shaft 310 inserted into the guide hole 210, the supporter 200 may move along the vertical direction.

For example, the supporter 200 may include a first guide hole 211. The first guide hole 211 may include a shape that is approximately laterally elongated (e.g., in the Y direction). The first guide hole 211 may include an approximately elliptical shape. A first shaft 311 to be described below may be insertable into the first guide hole 211. A detailed description of the first guide hole 211 will be provided below.

For example, the supporter 200 may include a second guide hole 212. The second guide hole 212 may be spaced apart from the first guide hole 211. The second guide hole 212 may include an approximately circular shape. A second shaft 312 to be described below may be insertable into the second guide hole 212. A detailed description of the second guide hole 212 will be provided below.

The supporter 200 may include a hole forming portion 220. The hole forming portion 220 may be provided in the sidewall portion 202. The hole forming portion 220 may be provided to form the guide hole 210. For example, the hole forming portion 220 may include an approximately cylindrical shape.

For example, the supporter 200 may include a first hole forming portion 221 provided to form the first guide hole 211.

For example, the supporter 200 may include a second hole forming portion 222 provided to form the second guide hole 212. The second hole forming portion 222 may be spaced apart from the first hole forming portion 221.

The supporter 200 may include a fixing hook 230. The fixing hook 230 may be formed on the sidewall portion 202. The fixing hook 230 may be provided to fix the supporter mounting portion 110. The supporter mounting portion 110 may be provided to be caught by the fixing hook 230. Thus, the sensor 100 may not be detached from the supporter 200 while seated on the supporter 200. The sensor 100 may not shake easily while moving in a state supported by the supporter 200. The sensor 100 may move stably along the vertical direction.

The supporter 200 may include a mounting protrusion 240. The mounting protrusion 240 may be formed on the bottom portion 201. The mounting protrusion 240 may be provided to be insertable into the mounting hole 111. Thus, the sensor 100 may not be detached from the supporter 200 while seated on the supporter 200. The sensor 100 may not shake easily while moving in a state supported by the supporter 200. The sensor 100 may move stably along the vertical direction.

The supporter 200 may include a board mounting portion 250. The board mounting portion 250 may be formed on the sidewall portion 202. A circuit board 730 to be described below may be detachably coupled to the board mounting portion 250 of the supporter 200. As an example, the circuit board 730 may be screw-coupled to the board mounting portion 250. However, the disclosure is not limited to the above example, and the circuit board 730 may be coupled to the board mounting portion 250 through various known methods.

The lifting assembly 40 may include a shaft 310. The shaft 310 may be provided to guide movement of the supporter 200. The shaft 310 may extend approximately along the vertical direction. With the shaft 310 inserted into the guide hole 210 of the supporter 200, the supporter 200 may move along the vertical direction.

For example, the lifting assembly 40 may include a first shaft 311. The first shaft 311 may be provided to be insertable into the first guide hole 211. The first shaft 311 may be provided to be inserted into the first guide hole 211 to guide movement of the supporter 200. The first shaft 311 may extend along the vertical direction.

For example, the lifting assembly 40 may include a second shaft 312. The second shaft 312 may be provided to be insertable into the second guide hole 212. The second shaft 312 may be provided to be inserted into the second guide hole 212 to guide movement of the supporter 200. The second shaft 312 may extend along the vertical direction.

The shaft 310 may be provided as a part of a base 300 to be described below. As an example, the shaft 310 may be provided to be press-fitted into the base 300.

The lifting assembly 40 may include a base 300. The base 300 may be provided such that the supporter 200 is supportable thereon. The base 300 may be provided to be fixed inside the housing 10, see FIGS. 1 to 3. The supporter 200 may be provided to be movable in the vertical direction relative to the base 300. The supporter 200 may be provided to move up and down relative to the base 200.

The lifting assembly 40 may include a power transmission member 500. The power transmission member 500 may be mechanically connected between the motor 400 and the supporter 200. The power transmission member 500 may be provided to transmit power to the supporter 200. The supporter 200 may move along the vertical direction by power transmitted from the power transmission member 500. The power transmission member 500 may receive power from a motor 400, to be described below, and provide the power received from the motor 400 to the supporter 200. The power transmission member 500 may convert a rotational motion of the motor 400 into a linear motion of the supporter 200.

The power transmission member 500 may be disposed on a lateral side of to the supporter 200. The power transmission member 500 may be disposed adjacent to the supporter 200.

The power transmission member 500 may also be referred to as a power transmission assembly 500. The power transmission member 500 may include a gear assembly including one or more gears. For example, the power transmission member 500 may include a first gear 510 and a second gear 520. The first gear 510 may extend along the vertical direction. The first gear 510 may be provided to mesh with the second gear 520 and move in the vertical direction. The first gear 510 may be formed on the supporter 200. As an example, the first gear 510 may be formed on the sidewall portion 202 of the supporter 200. The second gear 520 may be provided to mesh with the first gear 510. The second gear 520 may be connected to the motor 400. The second gear 520 may be provided to be connected to the motor 400 and rotate. The second gear 520 may be coupled to a rotation shaft 400a of the motor 400. As an example, a shaft coupling portion 521 connectable to the rotation shaft 400a of the motor 400 may be formed at the center of the second gear 520.

The second gear 520 may provide power generated by the motor 400 to the first gear 510. The first gear 510 may provide the power provided from the second gear 520 to the supporter 200. As the motor 400 rotates, the second gear 520 connected to the motor 400 may rotate. As the second gear 520 rotates, the first gear 510 meshing with the second gear 520 may move in the vertical direction. The supporter 200 on which the first gear 510 is formed may move along the vertical direction. Depending on the rotation direction of the motor 400, the supporter 200 may move upward (+Z direction) or downward (−Z direction).

The disclosure is not limited to the above example, and the power transmission member 500 may include various components for transmitting power such as belts, pulleys, chains, and the like, in addition to gears.

The lifting assembly 40 may include a motor 400. The motor 400 may be provided to generate power. The motor 400 may generate rotational force. Power generated by the motor 400 may be transmitted to the supporter 200 through the power transmission member 500. The motor 400 may be connected to the second gear 520 to provide power to the second gear 520. The rotation shaft 400a of the motor 400 may be coupled to the shaft coupling portion 421 of the second gear 520.

The lifting assembly 40 may include a motor cover 450. The motor cover 450 may be configured to attenuate and/or suppress (e.g., dampen) vibration generated by the motor 400.

The lifting assembly 40 may include a bracket 600. The bracket 600 may be provided to fix the motor 400 to the base 300. The motor 400 may be mounted on the base 300 through the bracket 600. For example, the bracket 600 may be detachably mounted on the base 300, and the motor 400 may be detachably mounted on the bracket 600. For example, the bracket 600 may be screw-coupled to the base 300, and the motor 400 may be coupled to the bracket 600. However, the disclosure is not limited to the above example, and the bracket 600 may fix the motor 400 to the base 300 through various known methods.

The bracket 600 may include an upper surface portion 610 and a lower surface portion 620. The lower surface portion 620 may be spaced apart from the upper surface portion 610 in the vertical direction. The lower surface portion 620 may be disposed below the upper surface portion 610. The bracket 600 may include a connecting portion 630 connecting the upper surface portion 610 and the lower surface portion 620.

The lifting assembly 40 may include a sensor 710. The sensor 710 may be detachably mounted on the supporter 200. As an example, the sensor 710 may be mounted on a circuit board 730, and the circuit board 730 may be coupled to the board mounting portion 250 of the supporter 200. While the sensor 710 is mounted on the supporter 200, the sensor 710 may move together with the supporter 200. That is, the sensor 710 may be mounted on the supporter 200 and move along the vertical direction.

The sensor 710 may be provided to detect physical contact with other components. The sensor 710 may be provided to contact the upper surface portion 610 of the bracket 600. The sensor 710 may be referred to as a touch sensor 710.

The lifting assembly 40 may include a sensor 720. The sensor 720 may be spaced apart from the sensor 710. The sensor 720 may be disposed below the sensor 710. The sensor 720 may be detachably mounted on the supporter 200. As an example, the sensor 720 may be mounted on the circuit board 730, and the circuit board 730 may be coupled to the board mounting portion 250 of the supporter 200. While the sensor 720 is mounted on the supporter 200, the sensor 720 may move together with the supporter 200. That is, the sensor 720 may be mounted on the supporter 200 and move along the vertical direction.

The sensor 720 may be provided to detect physical contact with other components. The sensor 720 may be provided to contact the lower surface portion 620 of the bracket 600. The sensor 720 may be referred to as a touch sensor 720.

The sensors 710 and 720 may limit the movement range of the supporter 200. When the sensor 710 contacts the upper surface portion 610 of the bracket 600, the sensor 100 supported by the supporter 200 may reach the first position P1. When the sensor 720 contacts the lower surface portion 620 of the bracket 600, the sensor 100 supported by the supporter 200 may reach the second position P2. When the sensor 100 reaches the first position P1 or the second position P2, movement of the supporter 200 along the vertical direction may be restricted. A detailed description of this will be provided below.

The lifting assembly 40 may include a circuit board 730. The sensors 710 and 720 may be mounted on the circuit board 730. The circuit board 730 may be detachably mounted on the board mounting portion 250 of the supporter 200.

Meanwhile, for distinction between sensors, the sensor 100 may be referred to as a first sensor 100, the sensor 710 may be referred to as a second sensor 710, and the sensor 720 may be referred to as a third sensor 720. The ordinal numbers “first,” “second,” and “third” are merely to distinguish the respective sensors and do not limit the configurations thereof.

The lifting assembly 40 may include a stopper 800. The stopper 800 may be coupled to the shaft 310. The stopper 800 may be coupled to the outer circumferential surface of the shaft 310. The stopper 800 may be disposed above the guide hole 210. When the supporter 200 moves along the vertical direction with the shaft 310 inserted into the guide hole 210, the stopper 800 may be provided to be contactable with the supporter 200. As an example, the stopper 800 may be provided to be contactable with the hole forming portion 220. While the stopper 800 contacts the supporter 200, the supporter 200 may be restricted from moving upward. As an example, the stopper 800 may include an E-ring.

For example, the lifting assembly 40 may include a first stopper 810 coupled to the first shaft 311. The first stopper 810 may be fitted into a groove 311a formed on the outer circumferential surface of the first shaft 311. The first stopper 810 may be disposed above the first guide hole 211. The first stopper 810 may be configured to be contactable with the first hole forming portion 221.

For example, the lifting assembly 40 may include a second stopper 820 coupled to the second shaft 312. The second stopper 820 may be fitted into a groove 312a formed on the outer circumferential surface of the second shaft 312. The second stopper 820 may be disposed above the second guide hole 212. The second stopper 820 may be configured to be contactable with the second hole forming portion 222.

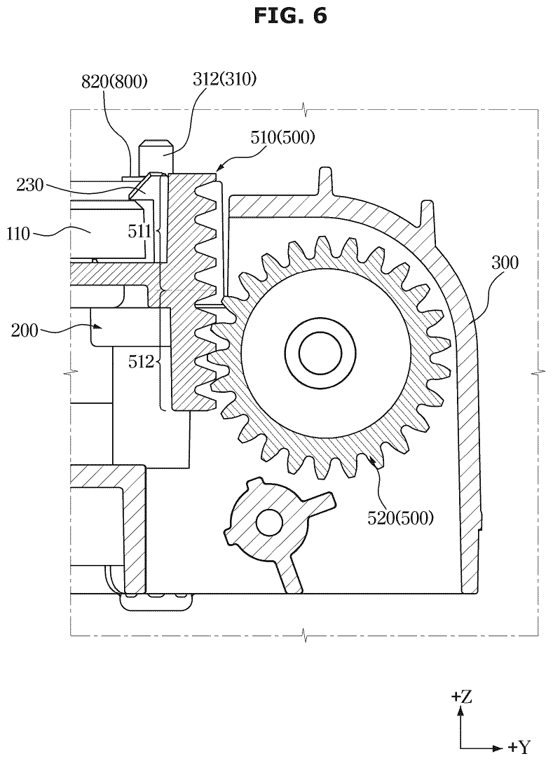

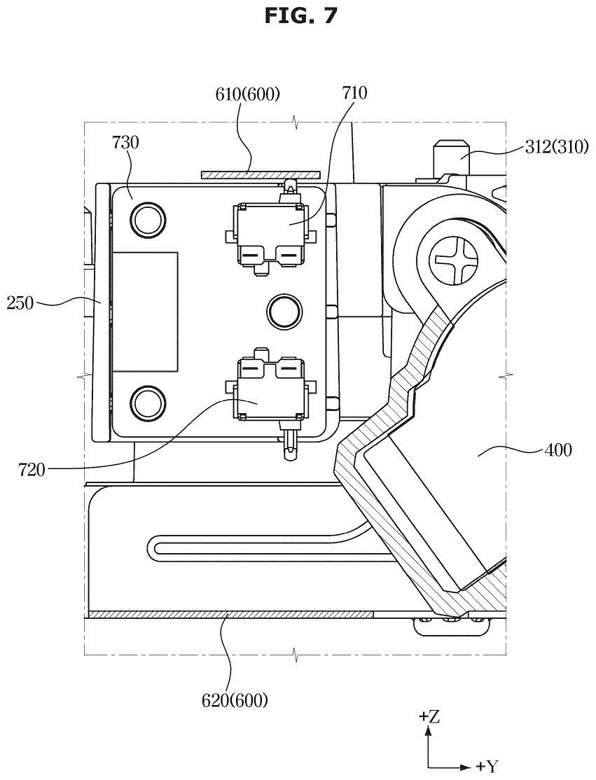

FIG. 5 shows a first state of a lifting assembly according to an embodiment of the disclosure. FIG. 6 is a cross-sectional view taken along line A-A′ of FIG. 5. FIG. 7 is a cross-sectional view taken along line B-B′ of FIG. 5.

Referring to FIGS. 5 to 7, the first state S1 of the lifting assembly 40 will be described.

While the electronic device 1 is moving, the lifting assembly 40 may be provided in the first state S1. While the lifting assembly 40 is in the first state S1, the first sensor 100 may be at the first position P1. While the first sensor 100 is at the first position P1, the first sensor 100 may protrude from the upper portion of the housing 10 (see FIG. 1). While the first sensor 100 is at the first position P1, the first sensor 100 may be exposed from the housing 10 (see FIG. 1). As an example, when the supporter 200 is positioned at the highest point, the first sensor 100 may be at the first position P1.

Referring to FIG. 5, the stopper 800 may be provided to contact the supporter 200 to restrict the supporter 200 from moving upward when the first sensor 100 is at the first position P1. The stopper 800 may press the supporter 200 downward. The supporter 200 may not be able to move upward from the first position P1 by interfering with the stopper 800. As an example, the first stopper 810 may be provided to contact the first hole forming portion 221. As an example, the second stopper 820 may be provided to contact the second hole forming portion 222.

Referring to FIG. 6, the first gear 510 may include an upper portion 511 and a lower portion 512. The lower portion 512 may extend downward from the upper portion 511. The upper portion 511 may be an upper region of the first gear 510 based on approximately a midpoint of the length of the first gear 510 along the vertical direction. The lower portion 512 may be a lower region of the first gear 510 based on approximately a midpoint of the length of the first gear 510 along the vertical direction. For example, while the first sensor 100 is at the first position P1, the lower portion 512 of the first gear 510 may mesh with the second gear 520.

Referring to FIG. 7, when the first sensor 100 is at the first position P1, the second sensor 710 may be provided to contact the upper surface portion 610 of the bracket 600. The second sensor 710 may generate a touch signal based on the contact with the upper surface portion 610 of the bracket 600. The second sensor 710 may detect that the first sensor 100 has reached the first position P1. As an example, the second sensor 710 may detect that the supporter 200 has reached the highest point.

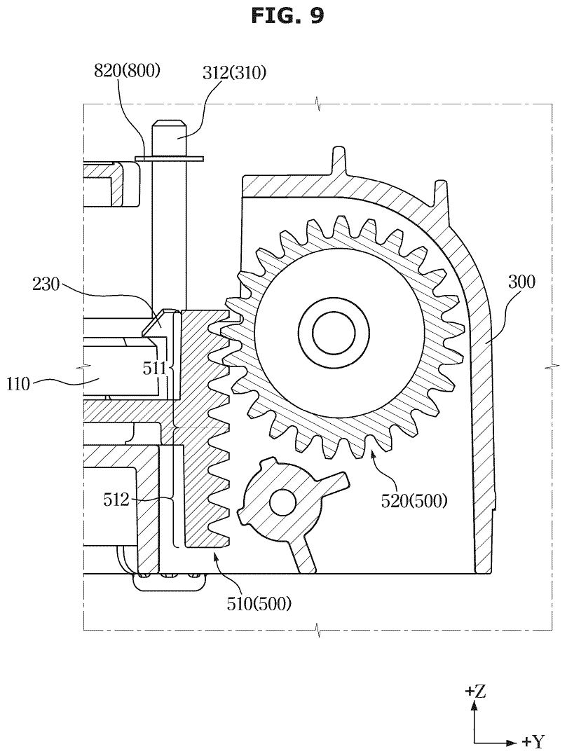

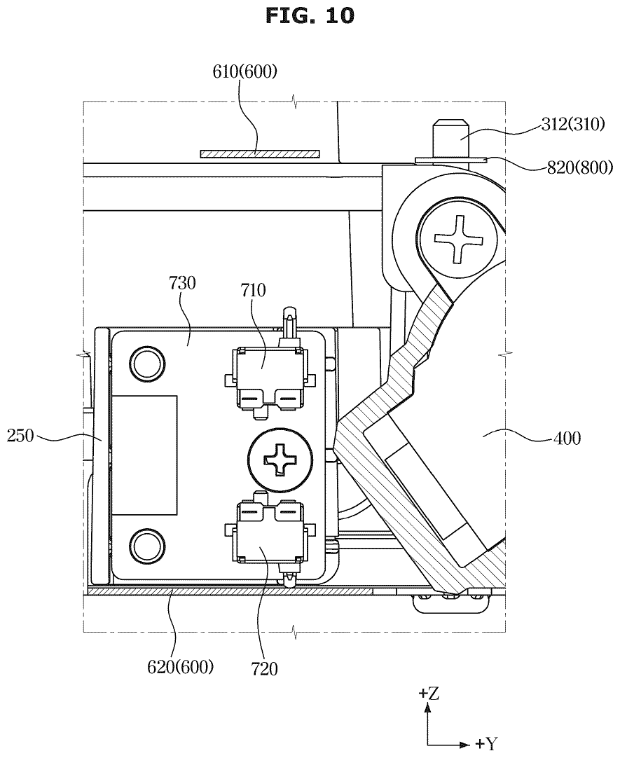

FIG. 8 shows a second state of a lifting assembly according to an embodiment of the disclosure. FIG. 9 is a cross-sectional view taken along line C-C′ of FIG. 8. FIG. 10 is a cross-sectional view taken along line D-D′ of FIG. 8.

Referring to FIGS. 8 to 10, the second state S2 of the lifting assembly 40 will be described.

While the electronic device 1 is stopped, the lifting assembly 40 may be provided in the second state S2. While the lifting assembly 40 is in the second state S2, the first sensor 100 may be at the second position P2. While the first sensor 100 is at the second position P2, the first sensor 100 may be disposed inside the housing 10 (see FIG. 2). While the first sensor 100 is at the second position P2, the first sensor 100 may not be exposed outside the housing 10 (see FIG. 2). As an example, when the supporter 200 is positioned at the lowest point, the first sensor 100 may be at the second position P2.

When the first sensor 100 is at the second position P2, the supporter 200 may be seated on the base 300. When the first sensor 100 is at the second position P2, the supporter 200 may be supported by the base 300. The supporter 200 may not be able to move downward from the second position P2 by interfering with the base 300.

Referring to FIG. 9, for example, while the first sensor 100 is at the second position P2, the upper portion 511 of the first gear 510 may mesh with the second gear 520.

Referring to FIG. 10, when the first sensor 100 is at the second position P2, the third sensor 720 may be provided to contact the lower surface portion 620 of the bracket 600. The third sensor 720 may generate a touch signal based on the contact with the lower surface portion 620 of the bracket 600. The third sensor 720 may detect that the first sensor 100 has reached the second position P2. As an example, the third sensor 720 may detect that the supporter 200 has reached the lowest point.

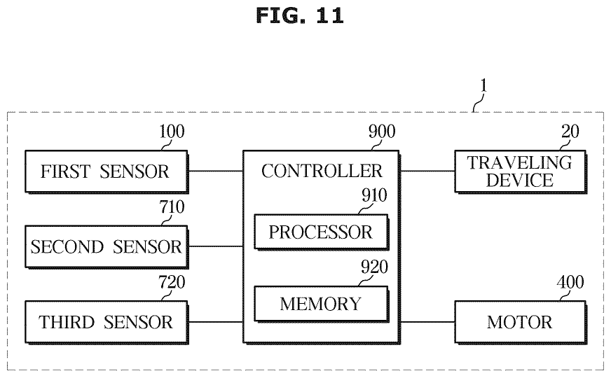

FIG. 11 is a control block diagram of an electronic device according to an embodiment of the disclosure.

Referring to FIG. 11, an electronic device 1 according to an embodiment of the disclosure may include a first sensor 100, a second sensor 710, a third sensor 720, a traveling device 20, a motor 400, and a controller 900.

The controller 900 may control the operation of the electronic device 1. The controller 900 may be electrically connected to various components of the electronic device 1.

The controller 900 may include hardware such as a CPU, a microcomputer, or memory, and software such as control programs. For example, the controller 900 may include at least one memory 920 that stores data in the form of algorithms and programs for controlling the operation of components of the electronic device 1. For example, the controller 900 may include at least one processor 910 that performs operations using the data stored in the at least one memory 920. The memory 920 and the processor 910 may each be implemented as separate chips. The processor 910 may include one or more processor chips or one or more processing cores. The memory 920 may include one or more memory chips or one or more memory blocks. In addition, the memory 920 and the processor 910 may be implemented as a single chip.

The first sensor 100 may be provided to detect obstacles. The first sensor 100 may collect information about the surrounding environment. The first sensor 100 may generate data (hereinafter referred to as obstacle data) about obstacles and transmit the obstacle data to the controller 900. The obstacle data generated by the first sensor 100 may include position information of obstacles and/or distance information to obstacles.

The controller 900 may identify external objects located around the electronic device 1 based on the obstacle data acquired through the first sensor 100. For example, the memory 920 of the controller 900 may store an artificial intelligence model for detecting external objects based on obstacle data.

The second sensor 710 may be provided to contact the upper surface portion 610 of the bracket 600 when the first sensor 100 reaches the first position P1. The second sensor 710 may generate a touch signal based on the contact with the upper surface portion 610 of the bracket 600 and transmit the touch signal to the controller 900.

The controller 900 may identify that the first sensor 100 has reached the first position P1 (e.g., the highest point) based on the touch signal acquired through the second sensor 710. The controller 900 may stop the operation of the motor 400 based on the touch signal being received from the second sensor 710. The controller 900 may stop the operation of the motor 400 based on the second sensor 710 contacting the upper surface portion 610. According to the first sensor 100 reaching the first position P1, the power transmission member 500 may not transmit power to the supporter 200. Thus, the first sensor 100 may not move above the first position P1.

The third sensor 720 may be provided to contact the lower surface portion 620 of the bracket 600 when the first sensor 100 reaches the second position P2. The third sensor 720 may generate a touch signal based on the contact with the lower surface portion 620 of the bracket 600 and transmit the touch signal to the controller 900.

The controller 900 may identify that the first sensor 100 has reached the second position P2 (e.g., the lowest point) based on the touch signal acquired through the third sensor 720. The controller 900 may stop the operation of the motor 400 based on the touch signal being received from the third sensor 720. The controller 900 may stop the operation of the motor 400 based on the third sensor 720 contacting the lower surface portion 620. According to the first sensor 100 reaching the second position P2, the power transmission member 500 may not transmit power to the supporter 200. Thus, the first sensor 100 may not move below the second position P2.

The traveling device 20 may move the main body of the electronic device 1. The traveling device 20 may include wheels and a wheel driver, but the disclosure is not limited thereto. In some embodiments, the traveling device 20 may include a conveyor, tracks, or another mobility method.

The controller 900 may control the traveling device 20. The controller 900 may control the traveling direction, traveling speed, and the like of the electronic device 1 by controlling the traveling device 20.

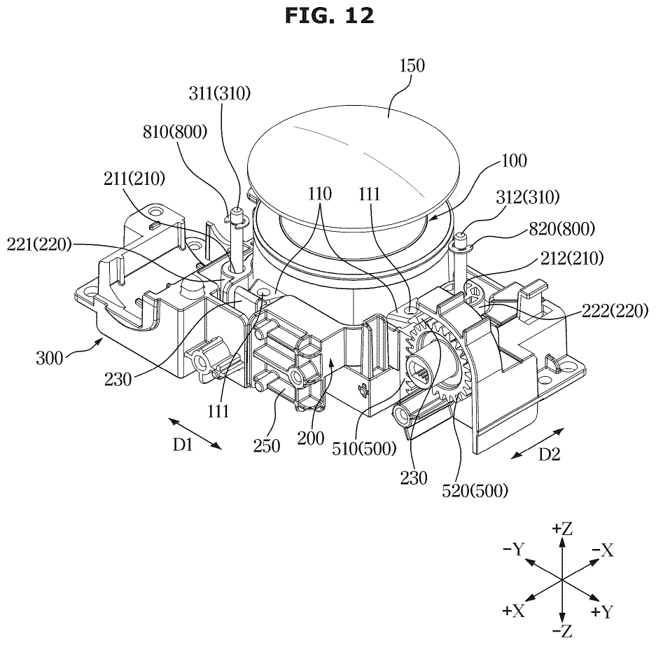

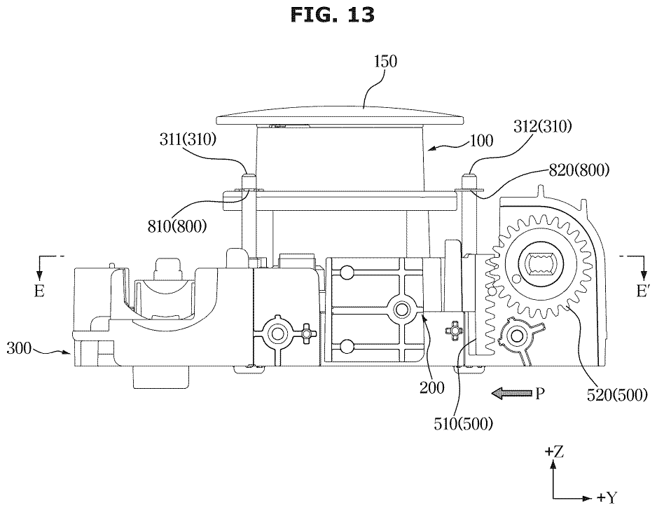

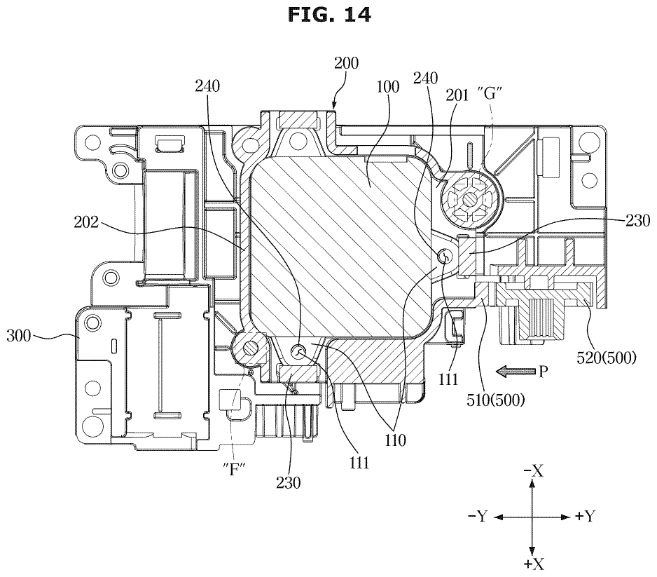

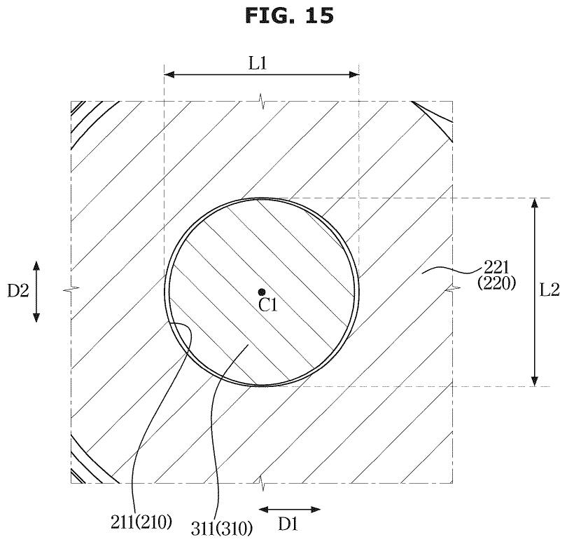

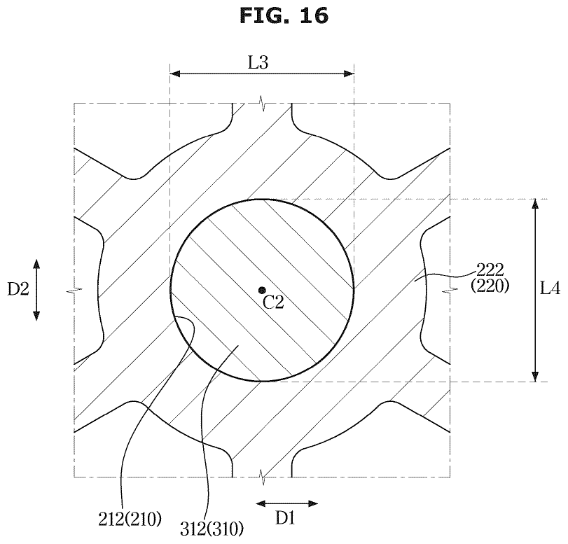

FIG. 12 shows a portion of a lifting assembly according to an embodiment of the disclosure. FIG. 13 is a front view of the lifting assembly shown in FIG. 12 according to an embodiment of the disclosure. FIG. 14 is a cross-sectional view taken along line E-E′ shown in FIG. 12 according to an embodiment of the disclosure. FIG. 15 is an enlarged view of portion F shown in FIG. 14 according to an embodiment of the disclosure. FIG. 16 is an enlarged view of portion G shown in FIG. 14 according to an embodiment of the disclosure.

The power transmission member 500 may be disposed on the lateral side of the supporter 200 to transmit power to the supporter 200. The supporter 200 may move along the vertical direction by the power transmitted from the power transmission member 500. The sensor 100 supported by the supporter 200 may also move along the vertical direction. For example, as the second gear 520 rotates, the first gear 510 meshing with the second gear 520 may move along the vertical direction. Thus, the supporter 200 on which the first gear 510 is formed may move along the vertical direction.

The power transmission member 500 may apply a force to the supporter 200. Since the power transmission member 500 is disposed on the lateral side of the supporter 200, the power transmission member 500 may apply a lateral force P in addition to a force in the vertical direction (Z direction). The power transmission member 500 may be provided to be disposed on the lateral side of the supporter 200 and apply a force P to the supporter 200 in a first direction D1. As the first gear 510 and the second gear 520 of the power transmission member 500 disposed on the lateral side of the supporter 200 mesh and operate, a force P may be generated. For example, a force P may be generated by friction between teeth of the first gear 510 and teeth of the second gear 520, the meshing angle of the first gear 510 and the second gear 520, and the like.

For example, the first direction D1 may intersect with the vertical direction (Z direction). The first direction D1 may be a direction intersecting with the direction of the rotation shaft (400a, see FIG. 4) of the motor 400. The first direction D1 may be approximately a horizontal direction (Y direction).

For example, a second direction D2 may intersect with the first direction D1. The second direction D2 may intersect with the vertical direction (Z direction). The second direction D2 may correspond to the direction of the rotation shaft 400a of the motor 400. The second direction D2 may be a direction parallel to the direction of the rotation shaft 400a of the motor 400. In the example of FIG. 12, the second direction D2 may be approximately a second horizontal direction (X direction), however the disclosure is not limited thereto.

As the power transmission member 500 applies the lateral force P to the supporter 200, the shaft 310 may become eccentric within the guide hole 210. As the supporter 200 receives the force P from the power transmission member 500, the shaft 310 may interfere with the supporter 200 (e.g., the hole forming portion 220), which may hinder movement of the supporter 200. That is, the supporter 200 may not move smoothly. In addition, the shaft 310 may be easily worn. To resolve such a limitation, a guide hole 210 may include an elongated hole shape. According to an embodiment, one guide hole 210 may include an elongated hole shape.

For example, referring to FIG. 15, the first guide hole 211 may include a laterally elongated shape. The first guide hole 211 may have an elongated shape along the direction in which the power transmission member 500 applies the force P to the supporter 200. The first guide hole 211 may include an elliptical shape. The first guide hole 211 may have a major axis and a minor axis. The distance from the center C1 of the first guide hole 211 to the edge of the first guide hole 211 may not be constant. The first guide hole 211 may have a first length L1 along the first direction D1 and a second length L2 along the second direction D2. The first guide hole 211 may have a first length L1 extending in a direction intersecting with the direction of the rotation shaft 400a of the motor 400 and a second length L2 extending in the direction of the rotation shaft 400a of the motor 400. The first length L1 may be greater than the second length L2.

The shape of the first guide hole 211 described above may allow the first shaft 311 to move to some extent along the first direction D1 within the first guide hole 211 when the supporter 200 receives the force P from the power transmission member 500. Thus, interference between the supporter 200 and the shaft 310 may be prevented and/or reduced. Interference between the first hole forming portion 221 and the first shaft 311 may be prevented and/or reduced. Collision between the first shaft 310 inserted within the first guide hole 211 of the supporter 200 and the supporter 200 may be minimized. As a result, the supporter 200 may move smoothly, and damage to the first shaft 311 may also be prevented and/or reduced. The lifespan of the lifting assembly 40 and the electronic device 1 including the lifting assembly 40 may be extended.

The shape of the first guide hole 211 described above may restrict movement of the first shaft 311 along the second direction D2 within the first guide hole 211 when the supporter 200 receives the force P from the power transmission member 500. Thus, the supporter 200 may be prevented from rotating about the second shaft 312 by receiving the force P from the power transmission member 500.

For example, referring to FIG. 16, the second guide hole 212 may include a circular shape. The diameter of the second guide hole 212 may be constant. The distance from the center C2 of the second guide hole 212 to the edge of the second guide hole 212 may be constant. The second guide hole 212 may have a third length L3 along the first direction D1 and a fourth length L4 along the second direction D2. The second guide hole 212 may have a third length L3 extending in a direction intersecting with the direction of the rotation shaft 400a of the motor 400 and a fourth length L4 extending in the direction of the rotation shaft 400a of the motor 400. The third length L3 and fourth length L4 may be approximately equal.

The shape of the second guide hole 212 described above may restrict movement of the second shaft 312 along the first direction D1 and the second direction D2 within the second guide hole 212 when the supporter 200 receives the force P from the power transmission member 500.

Among a plurality of guide holes 210, one guide hole 211 may have an elongated hole-shape, and another guide hole 212 may have a circular shape. Among a plurality of shafts 310, one shaft 311 may be inserted into the guide hole 211 having an elongated hole-shape to guide movement of the supporter 200, and another shaft 312 may be inserted into the guide hole 212 having a circular-shape to guide movement of the supporter 200. Accordingly, the supporter 200 may have one degree of freedom. That is, the supporter 200 may be configured to be movable in the vertical direction (Z direction). Meanwhile, although the drawings illustrate two guide holes 210 and two shafts 310, the disclosure is not limited thereto. The number of guide holes 210 and the number of shafts 310 are not limited.

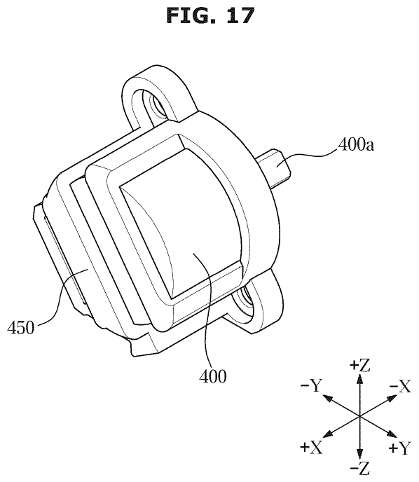

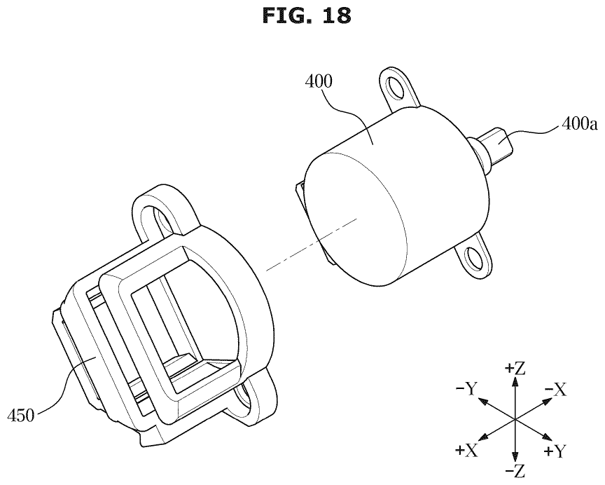

FIG. 17 shows a motor and a motor cover according to an embodiment of the disclosure. FIG. 18 shows an exploded view of the motor and the motor cover shown in FIG. 17.

Referring to FIGS. 17 and 18, the motor cover 450 may be provided to surround the motor 400. The motor cover 450 may be detachably coupled to the motor 400. The motor cover 450 may be coupled to the motor 400 to attenuate vibration generated by the motor 400. For example, the motor cover 450 may include rubber.

When the motor 400 operates, vibration may occur, and the vibration generated by the motor 400 may be transmitted to the supporter 200 and base 300. When the vibration is transmitted to the supporter 200 and the base 300, the supporter 200 may not move smoothly. In addition, the supporter 200 and/or the base 300 may be damaged by the vibration. To resolve such a limitation, the motor cover 450 may be configured to be coupled to the motor 400 to attenuate vibration. For example, the motor cover 450 may include a shape that covers the motor 400 along the Z-Y plane, and accordingly the motor cover 450 may effectively reduce vibration generated along the vertical direction (Z direction) and the lateral direction (Y direction).

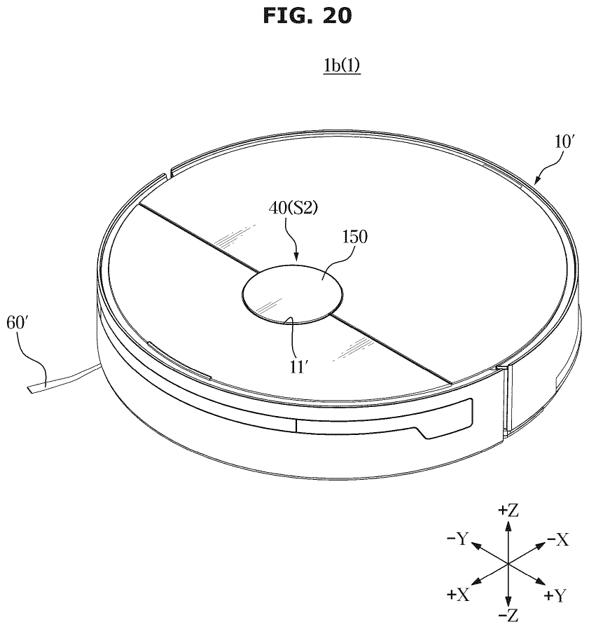

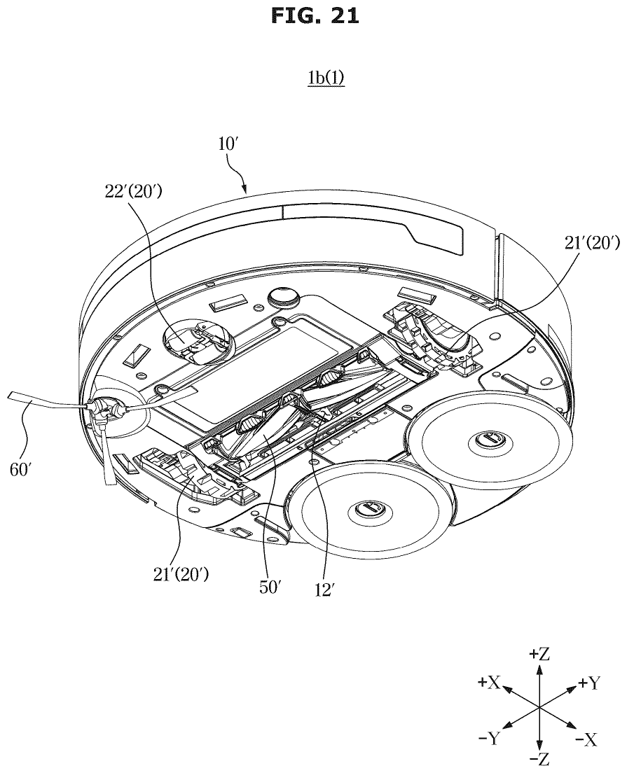

FIG. 19 shows an electronic device in a traveling state according to an embodiment of the disclosure. FIG. 20 shows an electronic device in a non-traveling state according to an embodiment of the disclosure. FIG. 21 shows an electronic device according to an embodiment of the disclosure, when viewed from below.

Referring to FIGS. 19 to 21, a robot cleaner 1b will be described as an example of the electronic device 1. Components substantially identical to those shown in FIGS. 1 to 18 are assigned the same reference numerals, and detailed descriptions may be omitted.

The robot cleaner 1b may clean a cleaning space by moving through the cleaning space and drawing in dirt such as dust accumulated on the floor. The robot cleaner 1b may perform dry cleaning and/or wet cleaning.

The robot cleaner 1b may include a housing 10′. The housing 10′ may form the overall appearance of the robot cleaner 1b. The housing 10′ may be provided to accommodate various components of the robot cleaner 1b. For example, the housing 10′ may be provided to accommodate a suction module, a dust container, and the like. For example, the housing 10′ may be provided to accommodate at least a portion of a lifting assembly 40. The housing 10′ may be referred to as a main body 10′, a case 10′, and the like. The housing 10′ may perform substantially the same function as the housing 10.

The robot cleaner 1b may include a suction port 12′. The suction port 12′ may be provided in a lower portion of the housing 10′. The suction port 12′ may be formed to face a surface to be cleaned. The suction port 12′ may be open toward the surface to be cleaned. Dirt on the surface to be cleaned may be drawn into the housing 10′ through the suction port 12′ together with air.

The robot cleaner 1b may include a brush. The brush may be provided on the lower portion of the housing 10′. The brush may strike the surface to be cleaned to scatter dirt. Dirt scattered by the brush may be introduced into the suction port 12′ together with air. As an example, the robot cleaner 1b may include a drum brush 50′ and a side brush 60′.

The robot cleaner 1b may include a traveling device 20′. The traveling device 20′ may be detachably mounted on the lower portion of the housing 10′. The traveling device 20′ may include at least one wheel 21′ and 22′ mounted on the lower portion of the housing 10′ and provided to move the housing 10′. As an example, the traveling device 20′ may include a pair of main wheels 21′ and an auxiliary wheel 22′. The traveling device 20′ may include a wheel driver for driving the at least one wheel. The traveling device 20′ may perform substantially the same function as the traveling device 20.

The robot cleaner 1b may include a lifting assembly 40. At least a portion of the lifting assembly 40 may be disposed inside the robot cleaner 1b. The lifting assembly 40 may include a sensor 100 for detecting obstacles and components for moving the sensor 100 up and down. Since the lifting assembly 40 has been described above, detailed descriptions of each component of the lifting assembly 40 will be omitted.

The lifting assembly 40 may be provided in a first state (S1, see FIG. 19) or a second state (S2, see FIG. 20). The lifting assembly 40 is switchable between the first state S1 and the second state S2.

When an operation of the sensor 100 is needed (e.g., when the robot cleaner 1b is in a traveling state), the lifting assembly 40 may be provided in the first state S1. While the lifting assembly 40 is in the first state S1, the sensor 100 may be at a first position P1 in which the sensor 100 protrudes from the housing 10′. As an example, the sensor 100 may protrude from the upper portion of the housing 10′ through an opening 11′ of the housing 10′. While the robot cleaner 1b is in the traveling state, the sensor 100 may be exposed outside the housing 10′ to detect objects located around the robot cleaner 1b.

When an operation of the sensor 100 is not needed (e.g., when the robot cleaner 1b is not in the traveling state), the lifting assembly 40 may be provided in the second state S2. While the lifting assembly 40 is in the second state S2, the sensor 100 may be at a second position P2 in which the sensor 100 is accommodated inside the housing 10′ (see FIG. 8). While the lifting assembly 40 is in the second state S2, the sensor 100 may be retracted into the housing 10′. While the robot cleaner 1b is not in the traveling state, the sensor 100 may not be exposed outside the housing 10′. While the robot cleaner 1b is not in the traveling state, the sensor 100 may be hidden inside the housing 10′.

According to an embodiment of the disclosure, an electronic device 1 may include: a housing 10; 10′; wheels 21; 21′ mounted on a lower portion of the housing 10; 10′; a sensor 100 configured to detect an obstacle; a supporter 200 configured to be movable in a vertical direction together with the sensor 100 while supporting the sensor 100, the supporter 200 including a guide hole 210; a shaft 310 configured to be insertable into the guide hole 210 of the supporter 200 to guide movement of the supporter 200; and a power transmission member 500 disposed on a lateral side of the supporter 200 and configured to transmit power to the supporter 200. The guide hole 210 may include a laterally elongated shape to prevent and/or reduce interference between the supporter 200 and the shaft 310.

As the supporter 200 moves along the vertical direction, the sensor 100 may be configured to be switchable between a first position P1 in which the sensor 100 protrudes from an upper portion of the housing 10; 10′ and a second position P2 in which the sensor 100 is accommodated inside the housing 10; 10′.

The guide hole 210 may be a first guide hole 211, the shaft 310 may be a first shaft 311. The supporter 200 may include a second guide hole 212 spaced apart from the first guide hole 211 and having a circular shape. The electronic device 1 may further include a second shaft 312 spaced apart from the first shaft 311 and configured to be insertable into the second guide hole 212.

The electronic device 1 may further include a motor 400 configured to generate the power. The power transmission member 500 may include: a first gear 510 formed on the supporter 200 and extending along the vertical direction, and a second gear 520 configured to mesh with the first gear 510 and coupled to a rotation shaft 400a of the motor 400.

The electronic device 1 may further include: a motor 400 configured to generate the power. The electronic device 1 may further include a motor cover 450 configured to surround the motor 400 to attenuate vibration generated by the motor 400.

The electronic device 1 may further include a motor 400 configured to generate the power. The guide hole 210 may have a first length L2 extending in a direction of a rotation shaft 400a of the motor 400 and a second length L1 extending in a direction intersecting with the direction of the rotation shaft 400a of the motor 400. The second length L1 may be greater than the first length L2.

The electronic device 1 may further include: a motor 400 configured to generate the power; a base 300 on which the supporter 200 is supportable; and a bracket 600 configured to fix the motor 400 to the base 300.

The sensor 100 may be a first sensor 100. The bracket 600 may include an upper surface portion 610 and a lower surface portion 620 spaced apart from the upper surface portion 610 in the vertical direction and disposed below the upper surface portion 610. The electronic device 1 may further include a second sensor 710 mounted on the supporter 200 and configured to contact the upper surface portion 610 of the bracket 600 when the first sensor 100 is at the first position P1. The electronic device 1 may further include a third sensor 720 mounted on the supporter 200 and configured to contact the lower surface portion 620 of the bracket 600 when the first sensor 100 is at the second position P2.

The electronic device 1 may further include: a controller 900 configured to stop operation of the motor 400 based on the second sensor 710 contacting the upper surface portion 610 of the bracket 600 or the third sensor 720 contacting the lower surface portion 620 of the bracket 600.

The electronic device 1 may further include a stopper 800 configured to contact the supporter 200 to restrict upward movement of the supporter 200 when the sensor 100 is at the first position P1.

The stopper 800 may be coupled to the shaft 310 and disposed above the guide hole 210.

The electronic device 1 may further include a base 300 on which the supporter 200 is supportable. The shaft 310 may be configured to be press-fitted into the base 300.

The electronic device 1 may further include a sensor cover 150 configured to cover an upper portion of the sensor 100 and to form part of an external appearance of the electronic device 1 when the sensor 100 is at the second position P2.

The sensor 100 may include a supporter mounting portion 110 configured to be mountable on the supporter 200. The supporter 200 may include a bottom portion 201 on which the sensor 100 is seated, a sidewall portion 202 extending upward from the bottom portion 201, and a fixing hook 230 formed on the sidewall portion 202 and configured to fix the supporter mounting portion 110.

The supporter mounting portion 110 may include a mounting hole 111. The supporter 200 may include a mounting protrusion 240 formed on the bottom portion 201 and insertable into the mounting hole 111.

According to an embodiment of the disclosure, a lifting assembly 40 may include: a base 300; a supporter 200 configured to be movable in a vertical direction relative to the base 300; a sensor 100 supported by the supporter 200 and configured to detect an obstacle; and a power transmission member 500 configured to transmit power to the supporter to move the supporter 200 supporting the sensor 100 in the vertical direction. The base 300 may include a first shaft 311 extending along the vertical direction, and a second shaft 312 spaced apart from the first shaft and extending along the vertical direction. The supporter 200 may include a first guide hole 211 into which the first shaft is inserted and which has an elliptical shape, and a second guide hole 212 into which the second shaft is inserted and which has a circular shape.

The power transmission member 500 may be disposed on a lateral side of the supporter and configured to apply a force to the supporter in a first direction D1. The first guide hole 211 may have a first length L1 along the first direction D1 and a second length L2 along a second direction D2 intersecting with the first direction. The first length L1 may be greater than the second length L2.

The lifting assembly 40 may further include a motor 400 configured to generate the power. The power transmission member 500 may include a first gear 520 connected to the motor 400 and rotate; and a second gear 510 configured to engage with the first gear 520 and move in the vertical direction, and formed on the supporter 200.

The sensor may be a first sensor 100. The lifting assembly 40 may include a bracket configured to fix the motor to the base, the bracket including an upper surface portion 610 and a lower surface portion 620 spaced apart from the upper surface portion 610 in the vertical direction and disposed below the upper surface portion 610. The lifting assembly 40 may further include a second sensor 710 mounted on the supporter 200 and configured to contact the upper surface portion 610 of the bracket 600 when the first sensor 100 is at the first position P1. The lifting assembly 40 may further include a third sensor 720 mounted on the supporter 200 and configured to contact the lower surface portion 620 of the bracket 600 when the first sensor 100 is at the second position P2.

The lifting assembly 40 may further include: a motor 400 configured to generate the power. The lifting assembly 40 may further include a motor cover 450 configured to surround the motor 400 to attenuate vibration generated by the motor 400.

According to various embodiments of the disclosure, since the power transmission member is disposed on the lateral side of the supporter, the lifting assembly and the electronic device including the lifting assembly may be more compact.

According to various embodiments of the disclosure, a guide hole among a plurality of guide holes of the supporter may have an elongated shape along the direction of the lateral force applied by the power transmission member to the supporter. Thus, interference between the supporter and the shaft may be prevented and/or reduced. Movement of the supporter supporting the sensor may be smooth. The lifespan of the lifting assembly and the electronic device including the lifting assembly may be extended.

According to various embodiments of the disclosure, when the electronic device is in a traveling state, the sensor may be exposed from the housing, and when the electronic device is not in a traveling state, the sensor may not be exposed from the housing. Thus, the aesthetics of the electronic device can be improved.

The effects of the present invention are not limited to those described above, and other effects that are not described above will be clearly understood by those skilled in the art from the above detailed description.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. An electronic device comprising:
a housing;
a wheel on a lower portion of the housing;
a sensor configured to detect an object;
a supporter on which the sensor is provided, the supporter comprising a guide hole and being configured to be movable in a vertical direction with the sensor;
a shaft configured to be insertable into the guide hole of the supporter and configured to guide movement of the supporter; and
a power transmission assembly on a lateral side of the supporter and configured to transmit power to the supporter,
wherein the guide hole comprises a laterally elongated shape and is configured to prevent interference between the supporter and the shaft.

2. The electronic device of claim 1, wherein the sensor is configured to be switchable between a first position in which the sensor protrudes from an upper portion of the housing and a second position in which the sensor is accommodated inside the housing, based on a movement of the supporter along the vertical direction.

3. The electronic device of claim 1, wherein the supporter further comprises a second guide hole spaced apart from the guide hole and comprising a circular shape, and
wherein the electronic device further comprises a second shaft spaced apart from the shaft and configured to be insertable into the second guide hole.

4. The electronic device of claim 1, further comprising a motor configured to generate the power,
wherein the power transmission assembly comprises:
a first gear on the supporter and extending along the vertical direction; and
a second gear coupled to a rotation shaft of the motor and configured to engage with the first gear.

5. The electronic device of claim 1, further comprising:
a motor configured to generate the power; and
a motor cover surrounding the motor and configured to dampen vibration generated by the motor.

6. The electronic device of claim 1, further comprising a motor configured to generate the power,
wherein the guide hole has a first length extending in a direction of a rotation shaft of the motor and a second length extending in a direction intersecting the direction of the rotation shaft of the motor, and
wherein the second length is greater than the first length.

7. The electronic device of claim 2, further comprising:
a motor configured to generate the power;
a base on which the supporter is supportable; and
a bracket configured to fix the motor to the base.

8. The electronic device of claim 7, wherein the bracket comprises an upper surface portion, and a lower surface portion spaced apart from the upper surface portion in the vertical direction, and
wherein the electronic device further comprises:
a second sensor on the supporter and configured to contact the upper surface portion of the bracket when the sensor is at the first position; and
a third sensor on the supporter and configured to contact the lower surface portion of the bracket when the sensor is at the second position.

9. The electronic device of claim 8, further comprising a controller configured to stop an operation of the motor based on the second sensor contacting the upper surface portion of the bracket or the third sensor contacting the lower surface portion of the bracket.

10. The electronic device of claim 2, further comprising a stopper configured to contact the supporter when the sensor is at the first position.

11. The electronic device of claim 10, wherein the stopper is coupled to the shaft and provided above the guide hole.

12. The electronic device of claim 1, further comprising a base on which the supporter is provided,
wherein the shaft is configured to be press-fitted into the base.

13. The electronic device of claim 2, further comprising a sensor cover on an upper portion of the sensor and forming at least part of an external portion of the housing when the sensor is at the second position.

14. The electronic device of claim 1, wherein the sensor comprises a supporter mount configured to be mountable on the supporter, and
wherein the supporter comprises a bottom portion on which the sensor is provided, a sidewall portion extending upward from the bottom portion, and a fixing hook formed on the sidewall portion and configured to fix the supporter mount.

15. The electronic device of claim 14, wherein the supporter mount comprises a mounting hole, and
wherein the supporter further comprises a mounting protrusion on the bottom portion and configured to be insertable into the mounting hole.

16. The electronic device of claim 2, further comprising:
a motor configured to generate the power; and
a controller configured to operate the motor to position the sensor at the first position when the electronic device is in a traveling state, and to position the sensor at the second position when the electronic device is not in the traveling state.

17. An electronic device comprising:
a housing;
a traveling device on the housing;
a sensor configured to detect an object;
a supporter on which the sensor is provided, the supporter comprising a guide hole and being configured to be movable in a vertical direction with the sensor;
a shaft configured to be insertable into the guide hole of the supporter and configured to guide movement of the supporter; and
a motor mechanically coupled to the supporter and configured to generate power to move the supporter,
wherein the guide hole comprises a laterally elongated shape and is configured to prevent interference between the supporter and the shaft.

18. The electronic device of claim 17, wherein the sensor is configured to be switchable between a first position in which the sensor protrudes from an upper portion of the housing and a second position in which the sensor is accommodated inside the housing, based on a movement of the supporter along the vertical direction.

19. The electronic device of claim 17, wherein the supporter further comprises a second guide hole spaced apart from the guide hole and comprising a circular shape, and
wherein the electronic device further comprises a second shaft spaced apart from the shaft and configured to be insertable into the second guide hole.

20. The electronic device of claim 17, wherein the guide hole has a first length extending in a direction of a rotation shaft of the motor and a second length extending in a direction intersecting the direction of the rotation shaft of the motor, and
wherein the second length is greater than the first length.
